(19) United States
(12) Patent Application Publication
(10) Pub. No.: US 2021/0114323 A1
(43) Pub. Date: Apr. 22, 2021

(54) TIRE BUILDING DRUM AND TURN-UP METHOD

(71) Applicant: VMI HOLLAND B.V., EPE (NL)

(72) Inventor: Evert Hendrik ZWEERS, EPE (NL)

(21) Appl. No.: 17/047,368

(22) PCT Filed: Mar. 15, 2019
(86) PCT No.: PCT/NL2019/050163

§ 371 Date: Oct. 13, 2020

(30) Foreign Application Priority Data
Apr. 13, 2018 (NL) 2020768

(51) Int. Cl. B29D 30/32

(52) U.S. Cl. CPC B29D 30/32; B29D 2030/325; B29D 2030/3242; B29D 2030/3228

(57) ABSTRACT

Disclosed is a tire building drum with a turn-up device and a turn-up method, wherein the tire building drum is rotatable about a central axis and includes a first drum half, a second drum half and a center section that is located in the axial direction between the first drum half and the second drum half, wherein the turn-up device includes a first turn-up bladder extending in a circumferential direction around the first drum half, wherein the turn-up device further includes a plurality of first pressing arms pivotable with respect to the first drum half between a rest position and a pressing position, wherein the plurality of first pressing arms in the rest position is arranged to lie at least partially between the uninflated first turn-up bladder and the first drum half in the radial direction.

### BACKGROUND

The invention relates to a tire building drum and a turn-up method.

Bladders have been widely used in tire building drums to turn-up tire components. In contrast to more rigid turn-up means such as turn-up rollers, bladders have the advantage that their contact surface is relatively smooth and therefore leaves less imprints in the tire components. This has become increasingly more important as tire components become thinner and are easily damaged.

U.S. Pat. No. 5,120,390 A discloses a tire carcass building drum with a bladder and a bladder guide shoe. The bladder guide shoe is supported on an axially extensible arm. When the bladder is inflated and begins to fold ply material around the bead ring and filler assembly, the axially extensible arm moves axially inward such that the bladder guide shoe engages the bladder, which causes the bladder to expand over and around the bead ring, carrying and folding the ply material around until the bead and filler assembly are fully enclosed. The known bladder guide shoe has the disadvantage its presence obstructs application and removal of tire components.

U.S. Pat. No. 3,692,605 A discloses a ply turn-up bladder for a tire building machine. As the bladder is inflated, the turned-down ply edges are progressively turned about the bead and the bladder is caused to roll over the outer diameter of the drum for pressing the edges of the plies against the outer surface of the drum either by inflation of a second annular bladder or by use of a pusher ring. If a second bladder is used for that purpose, it is disposed radially inwardly of the first bladder and lies flat there beneath when both bladders are deflated. In the deflated state, beads can be easily applied around the drum. After the side wall material has been accurately located on the tire by inflation of the bladders, the bladders are deflated again to permit further stitching of the side wall material if desired and to permit removal of the formed carcass from the drum.

KR 2003 0057166 A discloses a tire building drum with a plurality of turn-up fingers for turning up against a bladder. The turn-up fingers lie flat on the drum beneath the bladder when the bladder is uninflated. The turn-up fingers are provided with a hinge end that is coupled to the drum half at an axial position outside of the bladder. The turn-up fingers extend from the hinge end towards the center of the drum. The turn-up fingers are pneumatically driven. When turning-up, the tip of the turn-up finger locally rolls over the bladder from underneath the bladder towards the top of the bladder, thereby forcing the bladder upwards while the bladder expands towards and rolls over the tire components.

### SUMMARY OF THE INVENTION

Although the use of a second bladder in U.S. Pat. No. 3,692,605 A solves the technical problem of application and removal of tire components to and from the drum, the relative movement between the bladders is hard to control and—as such—the quality of the turn-up is less consistent. Moreover, a tire building drum typically comprises two drum halves, each with its own turn-up means. For a consistent turn-up, it is important that the turn-up means in both drum halves operate synchronously. However, it has proven difficult to synchronous bladder inflation across the two drum halves, e.g. because of pressure differences.

KR 2003 0057166 A provides a turn-up fingers which can control the shape of the bladder to a certain extent. However, the turn-up fingers, like the second bladder, are still pneumatically controlled. Hence, synchronous bladder operation across the drum halves will still prove difficult because of pressure differences. Moreover, the force exerted by the turn-up fingers on the bladder is predominantly in the radially outward direction, while the bladder has to be controlled predominantly in the axial direction because of the roll-over. Finally, the turn-up fingers of KR 2003 0057166 A press against the bladder only locally at the tip. As a result, the shape of the rest of bladder radially inside the turn-up fingers is fairly uncontrolled and will cause unpredictable behavior of the bladder during the turn-up.

It is an object of the present invention to provide a tire building drum with a turn-up device and a turn-up method, wherein the consistency of the turn-up can be improved.

According to a first aspect, the invention provides a tire building drum with a turn-up device, wherein the tire building drum is rotatable about a central axis extending in an axial direction and comprises a first drum half, a second drum half and a center section that is located in the axial direction between the first drum half and the second drum half, wherein the first drum half comprises a first bead clamp that defines a first bead clamp position, wherein the turn-up device comprises a first turn-up bladder extending in a circumferential direction about the central axis around the first drum half, wherein the first turn-up bladder is inflatable with respect to the first drum half for turning-up tire components supported on said first turn-up bladder, wherein the turn-up device further comprises a plurality of first pressing arms distributed in the circumferential direction and supported with respect to the first drum half at a side of the first bead clamp position in the axial direction opposite to the center section, wherein the plurality of first pressing arms are pivotable with respect to the first drum half between a rest position on the first drum half and a pressing position for pressing against the inflated first turn-up bladder, wherein the first turn-up bladder, when uninflated, is contracted in the circumferential direction around the first drum half, wherein the plurality of first pressing arms in the rest position is arranged to lie at least partially between the uninflated first turn-up bladder and the first drum half in a radial direction perpendicular to the central axis, wherein each first pressing arm is provided with a hinge end that is coupled to the first drum half, a distal end opposite to the hinge end and an arm body extending in an arm direction from the hinge end towards the distal end, wherein the arm direction in the rest position is directed away from the center section.

By using a plurality of first pressing arms, the movement of the first turn-up bladder with respect to the tire components during or after inflation can be controlled more accurately, thus resulting in a more consistent turn-up. Meanwhile, because the first pressing arms are arranged to lie at least partially between the uninflated first turn-up bladder and the first drum half in the radial direction, said first pressing arms can at least partially be contained within the circumference of the contracted first turn-up bladder. Consequently, with the first pressing arms in the rest position, the tire components can be applied to and removed from the tire building drum more easily. Moreover, as the arm direction extends away from the center section, the first pressing arm can be pivoted from the rest position to the pressing position to press against the first turn-up bladder predominantly in the axial direction, especially during the higher stages of the turn-up. The pivoting about a hinge end close to the center section also means that a considerable portion of the length of the first pressing arm can be made to contact the first turn-up bladder, thereby more accurately controlling its shape. Hence, a consistent turn-up and/or roll-over of the one or more tire components can be obtained.

In an embodiment thereof the plurality of first pressing arms in the rest position is arranged for at least partially supporting the uninflated first turn-up bladder in the radial direction with respect to the first drum half. The first pressing arms are thus not only contained within the circumference of the contracted first turn-up bladder, they also at least partially support and can thus define the way in which the contracted, uninflated first turn-up bladder is supported relative to the first drum half.

In a further embodiment the first turn-up bladder comprises a first circumferential edge that is connected to the first drum half, a second circumferential edge that is connected to the first drum half at a side of the first circumferential edge opposite to the center section in the axial direction and an inflatable bladder body extending between the first circumferential edge and the second circumferential edge, wherein the bladder body, when uninflated, folds onto itself about a fold line at a side of the second circumferential edge opposite to the center section in the axial direction, wherein the plurality of first pressing arms in the rest position is arranged for supporting the first turn-up bladder between the second circumferential edge and the fold line. Hence, at least the part of the first turn-up bladder that is folded onto itself can be effectively supported by the first pressing arms.

In an embodiment thereof the bladder body bulges at the fold line, wherein each first pressing arm is provided with a recess for at least partially receiving the bulge in the bladder body at said fold line. By recessing the bulge with respect to the rest of the bladder body, it can be prevented that said bulge protrudes radially outwards and prevents the application of tire components to or removal of tire components from the tire building drum.

Preferably, each recess extends over at least five centimeters or at least ten centimeters in the axial direction when the first pressing arms are in the rest position. Sometimes, different turn-up bladders are used with different dimensions. This may cause the fold line, and thus the bulge, to occur at a different position in the axial direction. Hence, depending on the dimensions of the first turn-up bladder, the bulge can still be received in the recess at different axial positions as long as they are within the range of said recess.

Alternatively, each pressing arm comprises a first telescopic part and a second telescopic part wherein the second telescopic part is telescopically extendable with respect to the first telescopic part in an extension direction that in the rest position of the respective pressing arm is parallel or substantially parallel to the axial direction, wherein the recess is provided in the second telescopic part. This allows for the recess to be positioned more accurately relative to the fold line.

In a further alternative embodiment, the recess extends in the axial direction up to the distal end. Hence, the recess effectively becomes a recessed end portion of the first pressing arm. Depending on the length of the recess in the axial direction, turn-up bladders with different dimensions can be received on the recessed end portion of the first pressing arm.

Preferably, the tire building drum is further provided with a plurality of insert blocks of different sizes, wherein each insert block of the plurality of insert blocks is interchangeably mountable in the recess to occupy at least a part of said recess corresponding to the size of the insert block. In this manner, the effective size of the recess in each of the previously discussed embodiments can be adjusted by mounting a suitably sized block into said recess. For example, when a relatively large turn-up bladder is used, a suitable sized insert block can be used to support the turn-up bladder in the recess just short of the location of the bulge at fold line.

In another embodiment the first pressing arms in the rest position extend parallel or substantially parallel to the axial direction to form a cylindrical or substantially cylindrical support surface for the uninflated turn-up bladder. By providing a substantially cylindrical support surface, application of tire components to and removal of tire components from the tire building drum in the axial direction can be facilitated.

Alternatively, the first pressing arms in the rest position form a conical or substantially conical support surface for the uninflated turn-up bladder, wherein said support surface tapers in the axial direction away from the center section. Hence, the tire components can be applied to or removed from the first drum half in the axial direction away from the center section without obstruction by the first pressing arms.

In another embodiment the first drum half is provided with a circumferentially extending abutment surface facing outwards in the radial direction for supporting the plurality of first pressing arms in the rest position. The abutment surface can prevent further radially inward pivoting of the first pressing arms beyond the rest position. Hence, the rest position can be reliably maintained.

In another embodiment the first drum half comprises a first bead clamp that defines a first bead clamp position for clamping a first bead to the first drum half, wherein the first turn-up bladder is supported on the first bead clamp at said first bead clamp position, wherein the first bead clamp is contractible together with the first turn-up bladder supported thereon so that the tire building drum has a release diameter at the first bead clamp position for releasing the first bead from the first drum half, wherein the first pressing arms in the rest position extend completely within said release diameter. Hence, the first pressing arms can be placed in a rest position that does not hinder the application or removal of the beads in the axial direction.

In an embodiment thereof the first turn-up bladder, when uninflated and supported on the first pressing arms in the rest position, extends completely within said release diameter. Hence, the first turn-up bladder can supported on the first pressing arms in an uninflated state that does not hinder the application or removal of the beads in the axial direction.

In a further embodiment the hinge end of each first pressing arm is coupled to the first drum half so as to be pivotable about a pivot axis, wherein the first drum half is provided with an annular element that is slidable in the axial direction, wherein the first drum half further comprises a plurality of linkages, one for each first pressing arm, that links the annular element to the respective first pressing arms at a distance from the respective pivot axes for converting the sliding movement of the annular element in the axial direction into the pivoting movement of respective first pressing arms about their respective pivot axes. The linkages can effectively convert the axial movement of the annular element into the pivoting movement of the first pressing arms.

In a further embodiment the arm body extends in the arm direction over an arm length, wherein the first drum half comprises a first bead clamp that defines a first bead clamp position for clamping a first bead to the first drum half, wherein the hinge end is coupled to the first drum half at a first pivot axis at a first spacing distance from the first bead clamp position in the axial direction that is smaller than the arm length. Consequently, the first pressing arm can effectively press against the first turn-up bladder, initially obliquely from below said first-turn-up bladder and ultimately predominantly in the axial direction.

In a further embodiment thereof the first drum half comprises a second pivot axis at a second spacing distance from the first bead clamp position in the axial direction that is smaller than the arm length and different from the first spacing distance, wherein the hinge end is detachable from the first drum half at the first pivot axis and connectable to the first drum half at the second pivot axis. By changing the position of the hinge end, the end position and/or orientation of the first pressing arms with respect to the first turn-up bladder can be adjusted, causing the first pressing arms to press harder or with a different distribution along the arm body.

In another embodiment the turn-up device comprises a second turn-up bladder and a plurality of second pressing arms at the second drum half, mirrored about the center section and synchronously operable with respect to the first turn-up bladder and the plurality of first pressing arms, respectively. By operating the pressing arms synchronously, difference between the turn-up at the first drum half and the second drum half can be prevented, thereby improving the consistency of the turn-up.

In an embodiment thereof the plurality of first pressing arms and the plurality of second pressing arms are connectable to a mechanical drive for synchronously pivoting the plurality of first pressing arms and the plurality of second pressing arms. In contrast to pneumatic drives, mechanical drives typically have less delay, thus providing a more instant and synchronous control of the pressing arms.

Preferably, the mechanical drive comprises two or more push-pull rods, wherein the turn-up device comprises two or more coupling members for connection to said two or more push-pull rods. The push-pull rods can provide an effective axial displacement that can be converted into synchronous pivoting movements of the plurality of first pressing arms and the plurality of second pressing arms.

Alternatively, the mechanical drive comprises a spindle with two oppositely threaded drive sections, wherein the turn-up device comprises a first threaded nut and a second threaded nut for connection to the two oppositely threaded drive sections. The opposite threads ensure that for each revolution of the spindle, the threaded nuts are moved over the same distance, yet in opposite directions. Hence, a synchronized control of the pivoting movements of the plurality of first pressing arms and the plurality of second pressing arms can be obtained.

According to a second aspect, the invention provides a method for turning-up tire components on a tire building drum according to any one of the aforementioned embodiments, wherein the method comprises the step of:

a) positioning the plurality of first pressing arms in the rest position;

b) supporting the first turn-up bladder in an uninflated state on the plurality of first pressing arms in the rest position;

c) inflating the first turn-up bladder to turn-up the tire components; and

d) pivoting the plurality of first pressing arms from the rest position towards the pressing position.

The method relates to the practical use of the tire building drum according to the first aspect of the invention and thus has the same technical advantages.

Preferably, step d) is performed after step c). Alternatively, step d) can be performed at least partially simultaneously with step c). By performing the steps sequentially, it can be ensured that the first turn-up bladder is fully inflated before the first pressing arms press against it. When performing the steps simultaneously, the first turn-up bladder can be deflected and/or pressed against the tire components early in the process, thereby ensure that also the initial turn-up is consistent.

In a further embodiment of the method, the turn-up device comprises a second turn-up bladder and a plurality of second pressing arms at the second drum half, mirrored about the center section with respect to the first turn-up bladder and the plurality of first pressing arms, respectively, wherein the method further comprises the step synchronously operating the plurality of second pressing arms with respect to the plurality of first pressing arms. By operating the pressing arms synchronously, differences between the turn-up at the first drum half and the second drum half can be prevented, thereby improving the consistency of the turn-up.

In another embodiment, the method further comprises the step of applying the tire components and/or beads in the axial direction to the tire building drum when the plurality of first pressing arms is in the rest position and the first turn-up bladder is uninflated. Additionally or alternatively, the method further comprises the step of removing the tire components and/or beads in the axial direction from the tire building drum when the plurality of first pressing arms is pivoted from the pressing position into the rest position and the first turn-up bladder is deflated. With the first pressing arms in the rest position and the first turn-up bladder in an uninflated or deflated state, the tire components can be applied to and removed from the tire building drum more easily.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 shows a cross section of a tire building drum with a turn-up device according to a first embodiment of the invention for turning-up tire components on the tire building drum;

FIG. 2 shows a cross section of the turn-up device at one of the drum halves according to FIG. 1 prior to the turn-up;

FIG. 3 shows a cross section of the turn-up device according to FIG. 2 during the turn-up;

FIG. 4 shows a cross section of the turn-up device according to FIG. 2 after the turn-up;

FIG. 5 shows cross section of an alternative tire building drum according to a second embodiment of the invention;

FIG. 6 shows a cross section of an alternative turn-up device according to a third embodiment of the invention;

FIG. 7 shows a cross section of an alternative turn-up device according to a fourth embodiment of the invention; and

FIG. 8 shows a cross section of an alternative turn-up device according to a fifth embodiment of the invention.

### DETAILED DESCRIPTION OF THE INVENTION

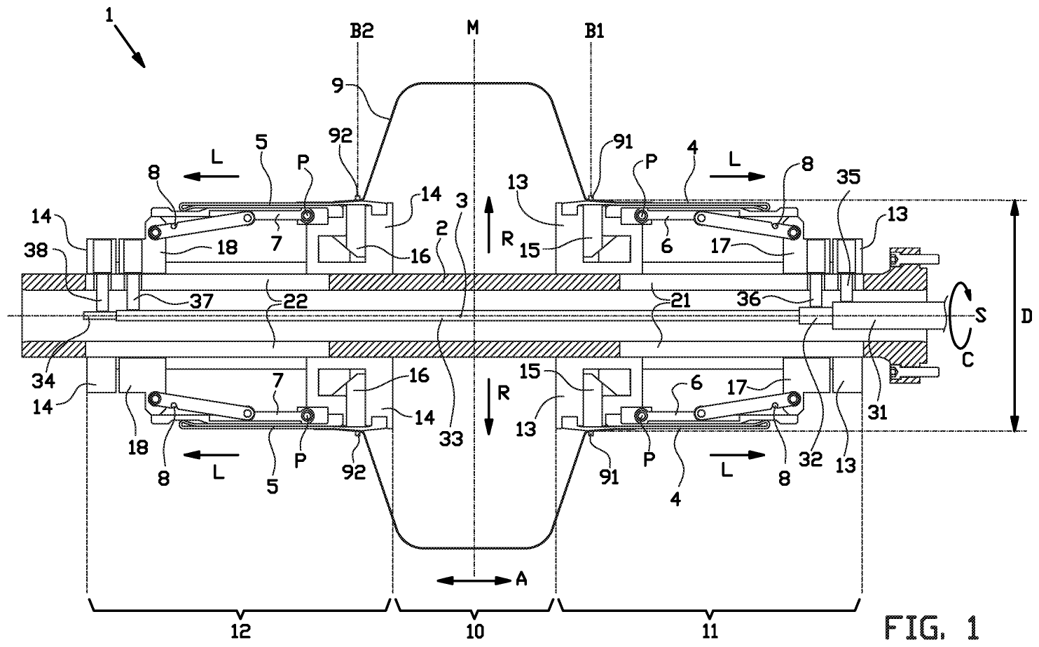

FIGS. 1-4 show a tire building drum 1 according to a first exemplary embodiment of the invention with a turn-up device for turning-up a tire component 9 supported on said tire building drum 1.

As shown in FIG. 1, the tire building drum 1 is rotatable about a central axis S extending in an axial direction A. In this example, the tire building drum 1 is mounted to and rotatable together with a drum shaft 2 that extends in the axial direction A along said central axis S. and rotatable about said drum shaft 2. The drum shaft 2 is hollow and comprises a drive 3, preferably a mechanical drive, within the drum shaft 2 for driving the different movements of the tire building drum 1 and the turn-up device in a manner that will be described hereafter in more detail.

The tire building drum 1 comprises a first drum half 11, a second drum half 12 and a center section 10 that is located in the axial direction A between the first drum half 11 and the second drum half 12. The drum halves 11, 12 extend in a circumferential direction C about the central axis S for supporting the one or more tire components 9 on either side of the center section 10. The drum halves 11, are slidable over the drum shaft 2 in the axial direction A towards and away from each other to shape the tire component 9 at the center section 10 in a manner known per se. In the situation as shown in FIG. 1, the one or more tire components 9 comprises a carcass that has been sealed in the circumferential direction C by beads 91, 92 which are arranged around the drum halves 11, 12 on either side of the center section 10. The carcass 9 has been shaped into a toroid shape by inflation of the carcass 9 at the center section 10 between the beads 91, 92. Alternatively, the carcass 9 can be shaped by mechanical means (not shown) at the center section 10.

As shown in FIG. 1, each drum half 11, 12 comprises a base 13, 14 that extends in the circumferential direction C about the drum shaft 2 and that is slidable over said drum shaft 2 in the axial direction A. The drum shaft 2 is provided with one or more slots 21, 22 extending in the axial direction A for connection of the bases 13, 14 of the respective drum halves 11, 12 and other moving parts of the tire building drum 1 to the drive 3 inside the drum shaft 2.

In this first embodiment of the invention, the drive 3 comprises a plurality of concentrically nested push-pull rods 31-34, for example as disclosed in WO 2011/019280 A1, which are arranged to be driven back and forth in the axial direction A within the drum shaft 2. In particular, the first push-pull rod 31 and the fourth push pull rod 34 are arranged to be driven synchronously towards and away from each other in the axial direction A. Similarly, the second push-pull rod 32 and the third push-pull rod 33 are arranged to be driven synchronously towards and away from each other in the axial direction A. In this example, the first drum half 11 and the second drum half 12 are coupled with their respective bases 13, 14 to the first push-pull rod 31 and the fourth push-pull rod 34, respectively, via coupling members 35, 38.

As shown in FIG. 1, each drum half 11, 12 further comprises a bead clamp 15, 16 that defines a bead clamp position B1, B2 for clamping the respective beads 91, 92 to the respective drum half 11, 12. The first turn-up bladder 4 and the second turn-up bladder 5 extend over and/or are supported on the first bead clamp 15 and the second bead clamp 16, respectively. The bead clamps 15, 16 are supported relative to and move together with the bases 13, 14 of the respective drum halves 11, 12 in the axial direction A. In particular, the bead clamps 15, 16 are expandable with respect to the bases 13, 14 in a radial direction R normal or perpendicular to the central axis S in a manner known per se to retain the bead 91, 92 by clamping. The bead clamps 15, 16 are contractible to a contracted position as shown in FIG. 1 for releasing the beads 91, 92 from the tire building drum 1. In particular, the bead clamps 15, 16 in the contracted position are arranged for supporting the respective turn-up bladders 4, 5 such that the tire building drum 1, at least at the bead clamp positions B1, B2, has an external diameter, e.g. a release diameter D, suitable for releasing the beads 91, 92 from the respective drum halves 11, 12, e.g. when the shaping of one or more tire components 9 has been completed.

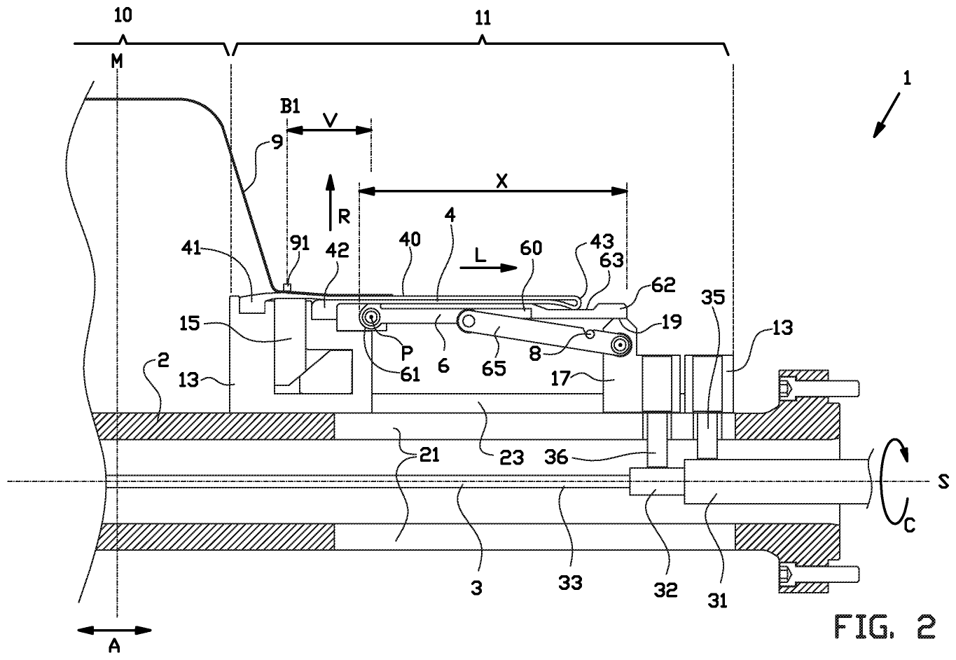

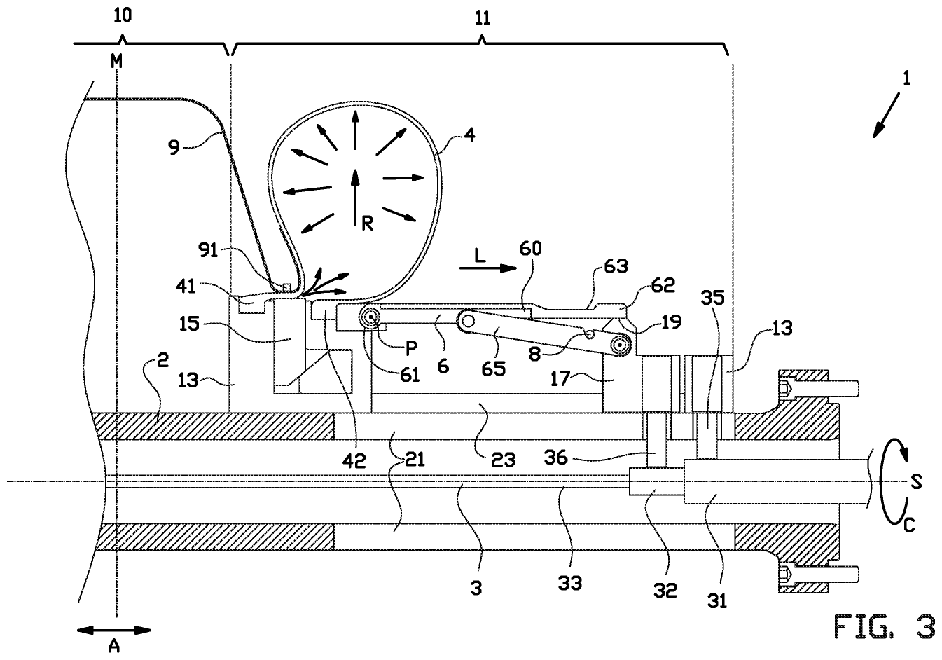

The turn-up device comprises a first turn-up bladder 4 and a second turn-up bladder 5 extending in a circumferential direction C about the central axis S around the first drum half 11 and the second drum half 12, respectively. Preferably, the first turn-up bladder 4 and the second turn-up bladder 5 are connected to the first drum half 11 and the second drum half 12, respectively, so as to move together with said drum halves 11, 12 in the axial direction A. The one or more tire components 9 extend at least partially over respective turn-up bladders 4, 5. In particular, the respective turn-up bladders 4, 5 are arranged for supporting the parts of the one or more tire components 9 that extend in the axial direction A away from the center section 10, e.g. beyond the bead clamp positions B1, B2. Each turn-up bladder 4, 5 is inflatable with respect to its respective drum half 11, 12 from an uninflated or deflated state, as shown in FIG. 2, towards an inflated state for turning-up the one or more tire components 9 against the shaped portion of said one or more tire component 9 at the center section 10, as shown in FIG. 3. Preferably, the turn-up bladder 4, 5 are inflatable in a radially outward direction, e.g. a direction with at least a component in a radial direction R perpendicular to the central axis S

In FIG. 2, the first turn-up bladder 4 at the first drum half 11 is shown in more detail. The following description of the first turn-up bladder 4 also applies to the second turn-up bladder 5 at the second drum half 12.

As shown in FIG. 2, the first turn-up bladder 4 comprises a first circumferential edge 41, a second circumferential edge 42 and an inflatable bladder body 40 extending between the first circumferential edge 41 and the second circumferential edge 42. The first circumferential edge 41 is connected to the first drum half 11, in particular at a side of the bead clamp position B1 that faces the center section 10 in the axial direction A. The second circumferential edge 42 is connected to the first drum half 11 at a side of the first circumferential edge 41 opposite to the center section 10 in the axial direction A, in particular at a side of the bead clamp position B1 opposite to the center section 10. Both circumferential edges 41, 42 are sealed at the first drum half 11 so that the inflatable bladder body 40 can form an air-tight volume around the first drum half 11. Because of the connection of the first turn-up bladder 4 to the first drum half 11 on opposite sides of the bead clamp position B1, the inflatable bladder body 40 is arranged to extend over the bead clamp 15. By arranging the bead 91 on the first turn-up bladder 4 at the bead clamp 15, the part of the inflatable bladder body 40 on the outside of the bead 91 with respect to the center section 10 can be effectively inflated outwards in the radial direction R.

The first turn-up bladder 4 is connected or connectable in fluid communication to an air pressure source in or external to the tire building drum 1, for inflation of the inflatable bladder body 40. In particular, the first turn-up bladder 4 is connected in fluid communication to the air pressure source via a connection between the first circumferential edge 41 and the second circumferential edge 42, e.g. via air channels extending at or between parts of the bead clamp 15.

As further shown in FIG. 2, the inflatable bladder body 40, when uninflated or deflated, contracts in the circumferential direction C towards and/or around the first drum half 11. As a result, the inflatable body 40 folds onto itself about a fold line 43 at a side of the second circumferential edge 42 opposite to the center section 10 in the axial direction A. In the uninflated state, the fold line 43 thus forms the far end of the first turn-up bladder 4 with respect to the center section 10. When uninflated, the inflatable bladder body 40 is arranged to fold flat or substantially flat, e.g. without wrinkles. The bladder body 40 tends to bulge slightly at or about the fold line 43.

As shown in FIG. 1, the turn-up device further comprises a plurality of first pressing arms 6 and a plurality of second pressing arms 7 distributed in the circumferential direction C about the central axis S at the first drum half 11 and the second drum half 12, respectively. The second pressing arms 7 are mirrored about the center section 10 with respect to the first pressing arms 6 and synchronously operable with the first pressing arms 6.

In FIG. 2, the plurality of first pressing arms 6 at the first drum half 1 is shown in more detail. The following description of the plurality of first pressing arms 6 also applies to the plurality of second pressing arms 7 at the second drum half 12.

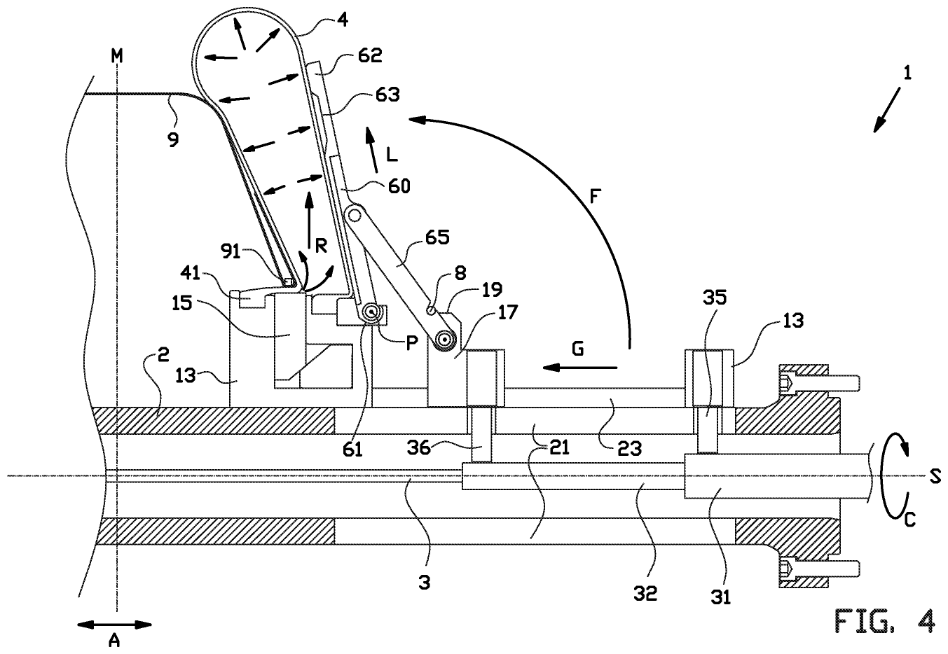

As shown in FIG. 2, the plurality of first pressing arms 6 is supported with respect to the first drum half 11 at a side of the first turn-up bladder 4 in the axial direction A opposite to the center section 10. The first pressing arm 6 may for example be coupled to or slidably supported on the first drum half 11. The plurality of first pressing arms 6 are pivotable with respect to the first drum half 11 between a rest position on the first drum half 11, as shown in FIG. 2, and a pressing position for pressing against the inflated first turn-up bladder 4, as shown in FIG. 4. More in particular, each first pressing arm 6 is pivotable about a pivot axis P tangent to the circumferential direction C at the position of the respective first pressing arm 6. Hence, each first pressing arm 6 is pivotable in a respective radial direction R or in a respective radial plane (not shown) in a pivoting movement F about the respective pivot axis P towards the first turn-up bladder 4.

Each first pressing arm 6 is provided with a hinge end 61 that is coupled to the first drum half 11 at the pivot axis P, a distal end 62 opposite to the hinge end 61 and an arm body 60 extending in an arm direction L from the hinge end 61 towards the distal end 62. The arm body 60 has an arm length X between the hinge end 61 and the distal end 62. In the rest position, the arm direction L is directed away from the center section 10. In other words, the arm body 60 extends from the hinge end 61 to the distal end 62 away from the center section 10 when the respective first pressing arm 6 is in the rest position. Hence, the first pressing arms 6 are arranged to pivot upwards against the first turn-up bladder 4.

More in particular, as schematically shown in FIG. 2, the hinge end 61 is coupled to the first drum half 11 at the first pivot axis P at a spacing distance V from the first bead clamp position B1 in the axial direction A. Said spacing distance V is smaller than the arm length X such that the first pressing arms 6, when pivoting from the rest position towards the pressing position, can effectively and consistently press the inflated first turn-up bladder 4 in the axial direction A towards the center section 10, initially obliquely from underneath the inflated first turn-up bladder 4, but ultimately predominantly in the axial direction A. Hence, a consistent turn-up and/or roll-over of the one or more tire components 9 can be obtained.

As shown in FIG. 4, the pivoting movement F of the first pressing arms 6 is driven by the drive 3 inside the drum shaft 2. In particular, the hinge end 61 of each first pressing arm 6 is coupled to the first drum half 11 at the base 13 so as to be pivotable about the pivot axis P and the first pressing arm 6 is connected to the drive 3 at a distance from the pivot axis P for pivoting the first pressing arm 6 about said pivot axis P. In this example, the first drum half 11 is provided with an annular element 17 that is slidably supported on the drum shaft 2. The first annular element 17 is connected via a coupling member 36 to the second push-pull rod 32. The second push-pull rod 32 is arranged to drive the first annular element 17 in a sliding movement G through a slot 23 in the base 13. The first drum half 11 further comprises a plurality of linkages 65, one for each first pressing arm 6, that links the first annular element 17 to the respective first pressing arms 6 at a distance from the respective pivot axes P for converting the sliding movement G of the first annular element 17 in the axial direction A into the pivoting movement F of respective first pressing arms 6 about their respective pivot axes P.

As shown in FIG. 1, a similar second annular element 18 is provided at the second drum half 12. Said second annular element 18 is coupled to the third push-pull rod 33 via a coupling member 37 so as to be driven synchronously with the first annular element 17 towards and away from the center section 10. Hence, the plurality of first pressing arms 6 and the plurality of second pressing arms 7 are connectable to the drive 3 for synchronously operating the plurality of first pressing arms 6 and the plurality of second pressing arms 7.

In the rest position, as shown in FIG. 2, the plurality of first pressing arms 6 is arranged to be supported on the first drum half 11. Preferably, the base of the first drum half 11 is provided with a circumferentially extending abutment surface 19 facing in the radial direction R for supporting the first pressing arms 6 in the rest position. In this particular example, the abutment surface 19 extends in the axial direction A at the position of the distal ends 62 of the respective first pressing arms 6. The abutment surface 19 can ensure that the first pressing arms 6 cannot be moved further radially inwards than the rest position.

The abutment surface 19 is arranged to support the first pressing arms 6 at a radial distance from the central axis S in which the first pressing arms 6 form a cylindrical or substantially cylindrical support surface for the first turn-up bladder 4 in the uninflated or deflated state. Alternatively, the abutment surface 19 may be arranged slightly radially inward to support the first pressing arms 6 to form a conical or substantially conical support surface that tapers in the axial direction A away from the center section 10.

In the rest position, as shown in FIG. 2, the plurality of first pressing arms 6 lies at least partially between the uninflated first turn-up bladder 4 and the first drum half 11 in the radial direction R. More in particular, the plurality of first pressing arms 6 is arranged for at least partially supporting the uninflated first turn-up bladder 4 in the radial direction R with respect to the first drum half 11. Specifically, the plurality of first pressing arms 6 in the rest position is arranged for supporting the first turn-up bladder 4 between the second circumferential edge 42 and the fold line 43.

As shown in FIG. 1, the first pressing arms 6 in the rest position extend completely within said release diameter D defined by the bead clamps 15, 16. Hence, the first pressing arms 6 can lie flush with or within the release diameter D that is required to apply or remove the one or more tire components 9 and/or the bead 91, 92 to or from the tire building drum 1 in the axial direction A. Preferably, the first pressing arms 6 in the rest position are arranged well within the release diameter D such that the first turn-up bladder 4, when uninflated and supported on the first pressing arms 6 in the rest position, also extends completely within said release diameter D. Hence, despite the presence of the first pressing arms 6, the first turn-up bladder 4 can be made to lie substantially flush with or within the release diameter D.

As shown in FIG. 2 and as previously discussed, the inflatable bladder body 40 of the first turn-up bladder, tends to bulge slightly at or about the fold line 43. To compensate for this bulge at the fold line 43, each first pressing arm 6 is optionally provided with a recess for at least partially receiving said bulge in the bladder body 40 at said fold line 43. More in particular, the recess 63 is located at a position along the arm body 60 in the arm direction L such that, when the respective first pressing arm 6 is in the rest position, the recess 63 is directly opposite to and/or aligned with the fold line in the uninflated bladder body 40 in the radial direction R. The recess extends in a direction parallel to the pivot axis P through the arm body 60 so that the recesses in the adjacent first pressing arms 6 together form a circumferentially extending channel (not shown) for receiving the circumferentially extending fold line 43.

In this example, the recess 63 extends over at least five centimeters and preferably at least ten centimeters in the axial direction A when the first pressing arms 6 are in the rest position. Hence, depending on dimension of the first turn-up bladder 4, the fold line 43 can be accommodated at different axial positions within the range of said recess 63.

As shown in FIGS. 2-4, the turn-up device is further provided with one or more biasing members 8 acting on the plurality of first pressing arms 6 to bias said pressing arms 6 to return from the pressing position towards the rest position. One or more similar biasing members 8 are provided at the plurality of second pressing arms 7 at the second drum half 12. In this example, the one or more biasing members 8 are formed by one or more annularly extending springs that are arranged in the circumferential direction C around the plurality of first pressing arms 6. The springs are arranged to contract in the circumferential direction C to bias the plurality of first pressing arms 6 to return from the pressing position towards the rest position. The one or more biasing members prevent that the pressing arms 6, 7 pivot radially outwards when the tire building drum 1 is disconnected from the drive 3 in the drum shaft 2.

A method for turning-up tire components 9 on the previously discussed tire building drum 1 will be described hereafter with reference to FIGS. 1-4.

FIG. 1 shows the situation in which one or more tire components 9, in particular a carcass, has been applied to the tire building drum 1. Beads 91, 92 have been applied in the axial direction A onto the tire building drum 1 and are sealingly clamped against the respective bead clamps 15, 16 in the bead clamp positions B1, B2. The part of the one or more tire components 9 between the bead clamp positions B1, B2 is shaped, e.g. by inflation, to assume a toroid shape. The plurality of first pressing arms 6 and the plurality of second pressing arms 7 are in the rest position with their arm directions L extending parallel to the axial direction A, in a direction away from the center section 10. The first turn-up bladder 4 and the second turn-up bladder 5 are uninflated or deflated after a previous cycle of the method. The first turn-up bladder 4 and the second turn-up bladder 5 are supported on the plurality of first pressing arms 6 and the plurality of second pressing arms 7, respectively, in the rest position.

FIG. 3 shows the situation after inflation of the first turn-up bladder 4 in the radial direction R. The second turn-up bladder 5 (not shown in FIG. 3) is inflated in a similar manner at the second drum half 12. The part of the one or more tire component 9 on the outside of the first bead clamp position B1 is at least partially turned-up by the inflated first turn-up bladder 4.

FIG. 4 shows the situation in which the plurality of first pressing arms 6 have been pivoted from the rest position towards the pressing position. During a first part of the pivoting movement F, the first pressing arms 6 are pressed against the first turn-up bladder 4 obliquely from below. Ultimately, as shown in FIG. 4, the first pressing arms 6 press predominantly in the axial direction A against the inflated first turn-up bladder 4. The pressing causes the first turn-up bladder 4 to complete the turn-up and/or roll over the one or more tire components 9 over the shaped part of said one or more tire components 9 at the center section 10. The drive 3 is operated to pivot the plurality of first pressing arms 6 and the plurality of second pressing arms 7 synchronously.

In FIGS. 2, 3 and 4, the step of pivoting the first pressing arms 6 is performed after the step of inflating the first turn-up bladder 4. Alternatively, these steps may be performed at least partially simultaneously.

After the turn-up has been completed, the first pressing arms 6 and the second pressing arms 7 are synchronously returned to their rest position on the first drum half 11 and the second drum half 12, respectively. The turn-up bladders 4, 5 are deflated and are supported on the respective returned pressing arms 6, 7. Now, the one or more tire components 9, including the beads 91, 92, can be removed in the axial direction A from the tire building drum 1 without being obstructed by the turn-up bladders 4, 5 or the pressing arms 6, 7.

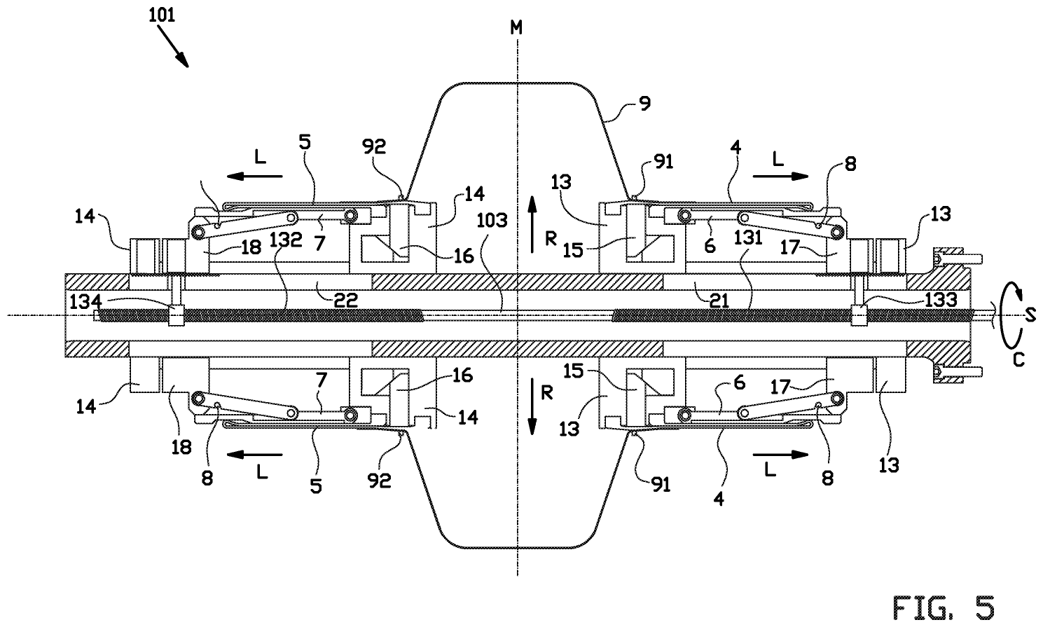

FIG. 5 shows an alternative tire building drum 101 according to a second embodiment of the invention. The alternative tire building drum 101 differs from the previously discussed tire building drum 1 in that it features an alternative drive 103, in particular an alternative to the push-pull rods 31-34 of the first embodiment. The alternative drive 103 comprises a spindle with two oppositely threaded drive sections 131, 132, as for example disclosed in WO 2009/142482 A1. The turn-up device comprises a first threaded nut 133 and a second threaded nut 134 for connection to the two oppositely threaded drive sections 131, 132. The first threaded nut 133 and the second threaded nut 134 are operationally connected to the first annular element 17 and the second annular element 18, respectively, for driving the pivoting movements of the respective pressing arms 6, 7. The bases 13, 14 of the respective drum halves 11, 12 can be driven by a second spindle (not shown) or by an external thread on the drum shaft 2.

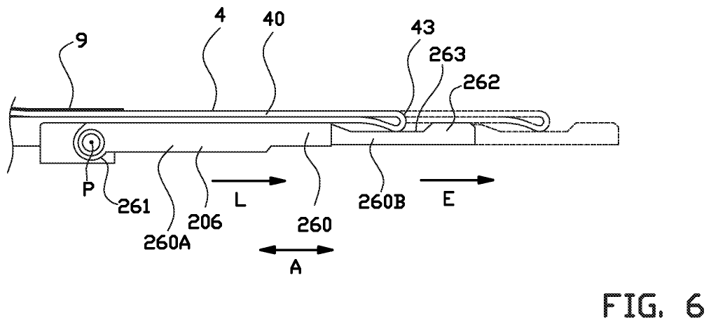

FIG. 6 shows an alternative first pressing arm 206 according to a third embodiment of the invention. The alternative first pressing arm 206 differs from the previously discussed first pressing arm 6 in that it features an arm body 260 that comprises a first telescopic part 260A and a second telescopic part 260B. The first telescopic part 260A is provided with the hinge end 261 and the second telescopic part 260B is provided with the distal end 262. The second telescopic part 260B is telescopically extendable with respect to the first telescopic part 260A in an extension direction E that in the rest position of the respective pressing arm 206 is parallel or substantially parallel to the axial direction A. The recess 263 for the bulge in the bladder body 40 at the fold line 43 is provided in the second telescopic part 260B such that the axial position of said recess 263 can be adjusted to match the axial position of the fold line 43.

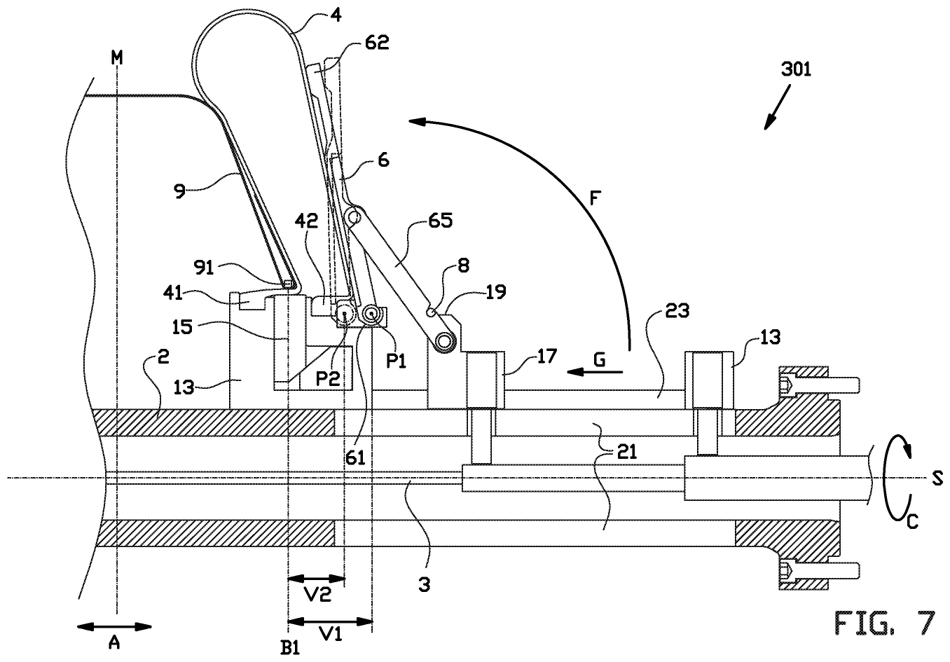

FIG. 7 shows a further alternative tire building drum 301 according to a fourth embodiment of the invention. The further alternative tire building drum 301 differs from the previously discussed tire building drums 1, 101 in that the first drum half (11) comprises a first pivot axis P1 at a first spacing distance V1 from the bead clamp position B1 in the axial direction A and a second pivot axis P2 at a second spacing distance V2 from the first bead clamp position B1 in the axial direction A. Both spacing distances V1, V2 are smaller than the arm length X, yet different from each other. The hinge end 61 is detachable from the first drum half 11 at the first pivot axis P1 and connectable to the first drum half 11 at the second pivot axis P2. By changing the position of the hinge end 61, the end position and/or orientation of the first pressing arms 6 with respect to the first turn-up bladder 4 can be adjusted, causing the first pressing arms 6 to press harder or with a different distribution along the arm body 60.

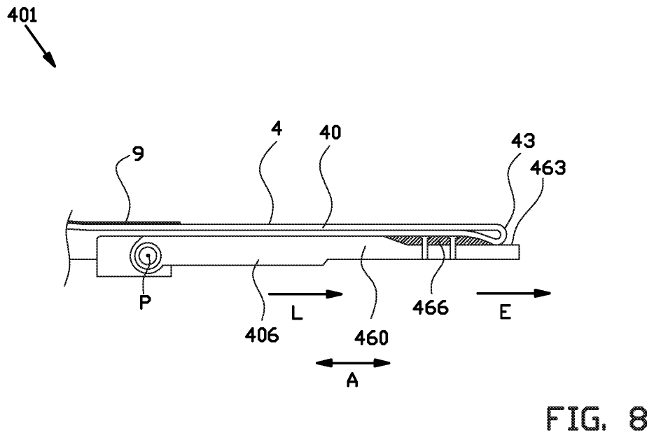

FIG. 8 shows a further alternative tire building drum 401 according to a fifth embodiment of the invention. The alternative tire building drum 401 differs from the previously discussed tire building drums 1, 101, 201, 301 in that its turn-up device features a first pressing arm 406 with a recess 463 that extends up to the distal end 462 of the first pressing arm 406. Hence, the recess 463 effectively becomes an end portion of the first pressing arm 406 that is recessed in the radially inward direction with respect to the rest of the first pressing arm 406. The arm body 460 does not have to be telescopic as in the embodiment of FIG. 6. Instead, the length of the recess 463 in the axial direction A determines the variation in bladder sizes that the first pressing arm 406 can handle. Depending on the length of the recess 463 in the axial direction A, a plurality of insert blocks 466 may be provided which are interchangeably mountable in the recess 463 to occupy at least a part of said recess 463 corresponding to the size of the insert block 466. In this manner, the effective size of the recess 463 can be adjusted by mounting a suitably sized insert block 466 into said recess 463.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

### LIST OF REFERENCE NUMERALS

1 tire building drum
10 center section
11 first drum half
12 second drum half
13 base
14 base
15 bead clamp
16 bead clamp
17 annular element
18 annular element
19 abutment surface
20 drum shaft
21 slot
22 slot
23 slot
3 drive
31 first push-pull rod
32 second push-pull rod
33 third push-pull rod
34 fourth push-pull rod
35 first coupling member
36 second coupling member
37 third coupling member
38 fourth coupling member
4 first turn-up bladder
40 inflatable bladder body
41 first circumferential edge
42 second circumferential edge
43 fold line
5 second turn-up bladder
6 first pressing arm
60 arm body
61 hinge end
62 distal end
63 recess
65 linkage
7 second pressing arm
8 biasing member
9 tire component
91 first bead
92 second bead
101 alternative tire building drum
103 alternative drive
131 first threaded section
132 second threaded section
133 first threaded nut
134 second threaded nut
206 alternative first pressing arm
260 arm body
260A first telescopic part
260B second telescopic part
261 hinge end
262 distal end
263 recess
301 further alternative tire building drum
401 further alternative tire building drum
406 alternative first pressing arm
463 recess or recessed end portion
466 insert block
A axial direction
B1 first bead clamp position
B2 second bead clamp position
C circumferential direction
D release diameter
E extension direction
F pivoting movement
G axial displacement
L arm direction
P pivot axis
P1 first pivot axis
P2 second pivot axis
S central axis
X arm length
V spacing distance
V1 first spacing distance
V2 second spacing distance

1. A tire building drum with a turn-up device, wherein the tire building drum is rotatable about a central axis extending in an axial direction and comprises a first drum half, a second drum half and a center section that is located in the axial direction between the first drum half and the second drum half, wherein the first drum half comprises a first bead clamp that defines a first bead clamp position, wherein the turn-up device comprises a first turn-up bladder extending in a circumferential direction about the central axis around the first drum half, wherein the first turn-up bladder is inflatable with respect to the first drum half for turning-up tire components supported on said first turn-up bladder, wherein the turn-up device further comprises a plurality of first pressing arms distributed in the circumferential direction and supported with respect to the first drum half at a side of the first bead clamp position in the axial direction opposite to the center section, wherein the plurality of first pressing arms are pivotable with respect to the first drum half between a rest position on the first drum half and a pressing position for pressing against the inflated first turn-up bladder, wherein the first turn-up bladder, when uninflated, is contracted in the circumferential direction around the first drum half, wherein the plurality of first pressing arms in the rest position is arranged to lie at least partially between the uninflated first turn-up bladder and the first drum half in a radial direction perpendicular to the central axis, wherein each first pressing arm is provided with a hinge end that is coupled to the first drum half, a distal end opposite to the hinge end and an arm body extending in an arm direction from the hinge end towards the distal end, and wherein the arm direction in the rest position is directed away from the center section.

2. The tire building drum according to claim 1, wherein the plurality of first pressing arms in the rest position is arranged for at least partially supporting the uninflated first turn-up bladder in the radial direction with respect to the first drum half.

3. The tire building drum according to claim 1, wherein the first turn-up bladder comprises a first circumferential edge that is connected to the first drum half, a second circumferential edge that is connected to the first drum half at a side of the first circumferential edge opposite to the center section in the axial direction and an inflatable bladder body extending between the first circumferential edge and the second circumferential edge, wherein the bladder body, when uninflated, folds onto itself about a fold line at a side of the second circumferential edge opposite to the center section in the axial direction, wherein the plurality of first pressing arms in the rest position is arranged for supporting the first turn-up bladder between the second circumferential edge and the fold line.

4. The tire building drum according to claim 3, wherein the bladder body bulges at the fold line, wherein each first pressing arm is provided with a recess for at least partially receiving the bulge in the bladder body at said fold line.

5. The tire building drum according to claim 4, wherein each recess extends over at least five centimeters in the axial direction when the first pressing arms are in the rest position.

6. The tire building drum according to claim 4, wherein each pressing arm comprises a first telescopic part and a second telescopic part, wherein the second telescopic part is telescopically extendable with respect to the first telescopic part in an extension direction that in the rest position of the respective pressing arm is parallel to the axial direction, wherein the recess is provided in the second telescopic part.

7. The tire building drum according to claim 4, wherein the recess extends in the axial direction up to the distal end.

8. The tire building drum according to claim 4, wherein the tire building drum is further provided with a plurality of insert blocks of different sizes, wherein each insert block of the plurality of insert blocks is interchangeably mountable in the recess to occupy at least a part of said recess corresponding to the size of the insert block.

9. The tire building drum according to claim 1, wherein the first pressing arms in the rest position extend parallel to the axial direction to form a cylindrical support surface for the uninflated first turn-up bladder.

10. The tire building drum according to claim 1, wherein the first pressing arms in the rest position form a conical support surface for the uninflated first turn-up bladder, wherein said support surface tapers in the axial direction away from the center section.

11. The tire building drum according to claim 1, wherein the first drum half is provided with a circumferentially extending abutment surface facing outwards in the radial direction for supporting the plurality of first pressing arms in the rest position.

12. The tire building drum according to claim 1, wherein the first drum half comprises a first bead clamp that defines a first bead clamp position for clamping a first bead to the first drum half, wherein the first turn-up bladder is supported on the first bead clamp at said first bead clamp position, wherein the first bead clamp is contractible together with the first turn-up bladder supported thereon so that the tire building drum has a release diameter at the first bead clamp position for releasing the first bead from the first drum half, wherein the first pressing arms in the rest position extend completely within said release diameter.

13. The tire building drum according to claim 12, wherein the first turn-up bladder, when uninflated and supported on the first pressing arms in the rest position, extends completely within said release diameter.

14. The tire building drum according to claim 1, wherein the hinge end of each first pressing arm is coupled to the first drum half so as to be pivotable about a pivot axis, wherein the first drum half is provided with an annular element that is slidable in the axial direction, wherein the first drum half further comprises a plurality of linkages, one for each first pressing arm, that links the annular element to the respective first pressing arms at a distance from the respective pivot axes for converting the sliding movement of the annular element in the axial direction into the pivoting movement of respective first pressing arms about their respective pivot axes.

15. The tire building drum according to claim 1, wherein the arm body extends in the arm direction over an arm length, wherein the first drum half comprises a first bead clamp that defines a first bead clamp position for clamping a first bead to the first drum half, wherein the hinge end is coupled to the first drum half at a first pivot axis at a first spacing distance from the first bead clamp position in the axial direction that is smaller than the arm length.

16. The tire building drum according to claim 15, wherein the first drum half comprises a second pivot axis at a second spacing distance from the first bead clamp position in the axial direction that is smaller than the arm length and different from the first spacing distance, wherein the hinge end is detachable from the first drum half at the first pivot axis and connectable to the first drum half at the second pivot axis.

17. The tire building drum according to claim 1, wherein the turn-up device comprises a second turn-up bladder and a plurality of second pressing arms at the second drum half, mirrored about the center section and synchronously operable with respect to the first turn-up bladder and the plurality of first pressing arms, respectively.

18. The tire building drum according to claim 17, wherein the plurality of first pressing arms and the plurality of second pressing arms are connectable to a mechanical drive for synchronously pivoting the plurality of first pressing arms and the plurality of second pressing arms.

19. The tire building drum according to claim 18, wherein the mechanical drive comprises two or more push-pull rods, wherein the turn-up device comprises two or more coupling members for connection to said two or more push-pull rods.

20. The tire building drum according to claim 18, wherein the mechanical drive comprises a spindle with two oppositely threaded drive sections, wherein the turn-up device comprises a first threaded nut and a second threaded nut for connection to the two oppositely threaded drive sections.

21. Method A method for turning-up tire components on a tire building drum with a turn-up device according to claim 1, wherein the tire building drum is rotatable about a central axis extending in an axial direction and comprises a first drum half, a second drum half and a center section that is located in the axial direction between the first drum half and the second drum half, wherein the first drum half comprises a first bead clamp that defines a first bead clamp position, wherein the turn-up device comprises a first turn-up bladder extending in a circumferential direction about the central axis around the first drum half, wherein the first turn-up bladder is inflatable with respect to the first drum half for turning-up tire components supported on said first turn-up bladder, wherein the turn-up device further comprises a plurality of first pressing arms distributed in the circumferential direction and supported with respect to the first drum half at a side of the first bead clamp position in the axial direction opposite to the center section, wherein the plurality of first pressing arms are pivotable with respect to the first drum half between a rest position on the first drum half and a pressing position for pressing against the inflated first turn-up bladder, wherein the first turn-up bladder, when uninflated, is contracted in the circumferential direction around the first drum half, wherein the plurality of first pressing arms in the rest position is arranged to lie at least partially between the uninflated first turn-up bladder and the first drum half in a radial direction perpendicular to the central axis, wherein each first pressing arm is provided with a hinge end that is coupled to the first drum half, a distal end opposite to the hinge end and an arm body extending in an arm direction from the hinge end towards the distal end, and wherein the arm direction in the rest position is directed away from the center section, wherein the method comprises the step of:
a) positioning the plurality of first pressing arms in the rest position;
b) supporting the first turn-up bladder in an uninflated state on the plurality of first pressing arms in the rest position;
c) inflating the first turn-up bladder to turn-up the tire components; and
d) pivoting the plurality of first pressing arms from the rest position towards the pressing position.

22. The method according to claim 21, wherein step d) is performed after step c).

23. The method according to claim 21, wherein step d) is performed at least partially simultaneously with step c).

24. The method according to claim 21, wherein the turn-up device comprises a second turn-up bladder and a plurality of second pressing arms at the second drum half, mirrored about the center section with respect to the first turn-up bladder and the plurality of first pressing arms, respectively, wherein the method further comprises the step synchronously operating the plurality of second pressing arms with respect to the plurality of first pressing arms.

25. The method according to claim 21, wherein the method further comprises the step of applying the tire components or beads in the axial direction to the tire building drum when the plurality of first pressing arms is in the rest position and the first turn-up bladder is uninflated.

26. The method according to claim 21, wherein the method further comprises the step of removing the tire components or beads in the axial direction from the tire building drum when the plurality of first pressing arms is pivoted from the pressing position into the rest position and the first turn-up bladder is deflated.
